(19) United States
(12) Patent Application Publication
(10) Pub. No.: US 2009/0103400 A1
(43) Pub. Date: Apr. 23, 2009

(54) CASE FOR WRISTWATCH

(75) Inventor: Cedric Grandperret, Beaumont (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MONTRES WYLER SA GENEVE, Geneve (CH)

(21) Appl. No.: 12/294,561

(22) PCT Filed: Mar. 20, 2007
(86) PCT No.: PCT/CH07/00152

§ 371 Date: Sep. 25, 2008

(30) Foreign Application Priority Data
Mar. 30, 2006 (EP) 6405135.2

(51) Int. Cl. G04B 37/18

(52) U.S. Cl. 368/283

(57) ABSTRACT

This watch case comprises a closed enclosure to take a watch movement, having a middle traversed by at least one control stem, to which middle are fixed both a base and a glass. This closed enclosure is housed in an outer jacket having an upper element with an opening for the passage of the glass, a base and a side wall with means of connection to the strap and with at least one passage for said control stem, while elastic suspension means are arranged between the base of the jacket and said enclosure in order to exert, on a bearing surface of the middle at the periphery of said glass, a pressure that will tend to keep this bearing surface of the middle pressed permanently against the edge of said opening for the passage of the glass.

The present invention relates to a case for a wristwatch, comprising a closed cell designed to accommodate a watch movement and having a middle through which there passes at least one control stem and to which there are fixed on the one hand a back and on the other hand a crystal, this closed cell being housed in an outer jacket having a top component containing an opening for the crystal to pass through, a back and a side wall that is provided both with means of connection to the wrist band and with at least one passage for said control stem, elastic means being arranged between the back of the jacket and said cell to apply, to a bearing surface which is part of the middle and is situated at the periphery of said crystal, a pressure such as to keep this bearing surface of the middle permanently applied to the edge of said opening for the passage of the crystal.

A watch case of the abovementioned type was disclosed in EP 1 076 273. The elastic means arranged between the back of the jacket and the cell that takes the watch movement are made of synthetic resin. The elastic properties of these resins are relatively weak, so the impact damping effect of such a construction is still limited.

The main purpose of a watch case is to protect the watch movement. The watch case is also, together with the watch dial, generally the only visible part of the watch, so the case is also a component that has an aesthetic role to play because, as with a car, its appearance is a component in the purchaser's choice. If it is wished to modify the appearance of the case, another case must be made, even if the technical features by which the movement is contained do not change.

The case of a wristwatch is also exposed to all sorts of abuse, particularly knocks.

It is an object of the present invention both to make it possible to modify the appearance of the watch without having to change the whole watch every time, and to give the watch greater protection against knocks.

To this end, the subject of the present invention is a case for the wristwatch as claimed in claim 1.

One of the advantages of this case is that the appearance of the outer jacket can be changed without changing the closed cell containing the watch movement. Advantageously, this closed cell is sealed. The part designed to contain the movement therefore never changes for a given movement: only the outer jacket, which will be simple to produce because it no longer has to perform the functions of containing and sealing the movement, is modified. Moreover, the elastic suspension of the closed cell inside the outer jacket gives added protection, which is particularly useful for a sports watch. The outer jacket does not need to be sealed. It simply has means for attaching it to the wrist band, and this also simplifies the production of the middle of the closed cell because it no longer has horns.

Other advantages of the present invention will become apparent in the course of the following description, given with the aid of the appended drawings which show, schematically and by way of example, one embodiment of the wristwatch case of this invention.

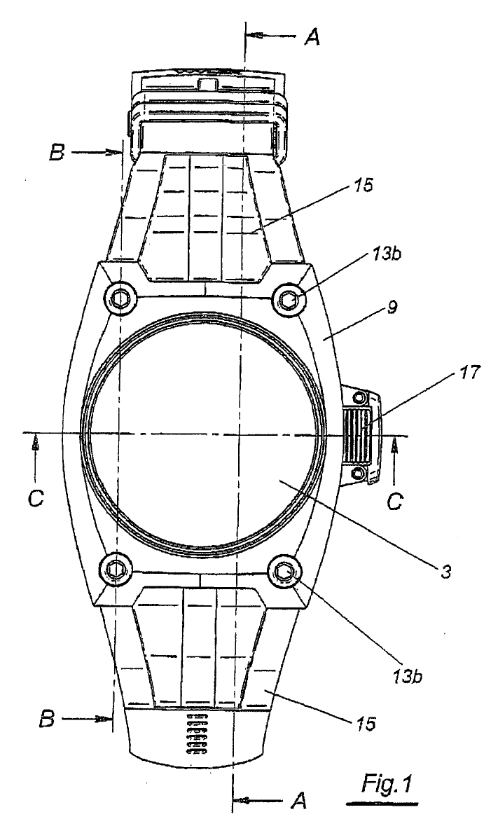

FIG. 1 is a top view of this embodiment;

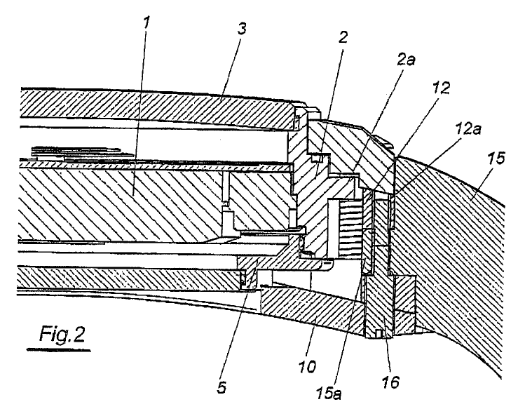

FIG. 2 is a cross section on A-A as marked in FIG. 1;

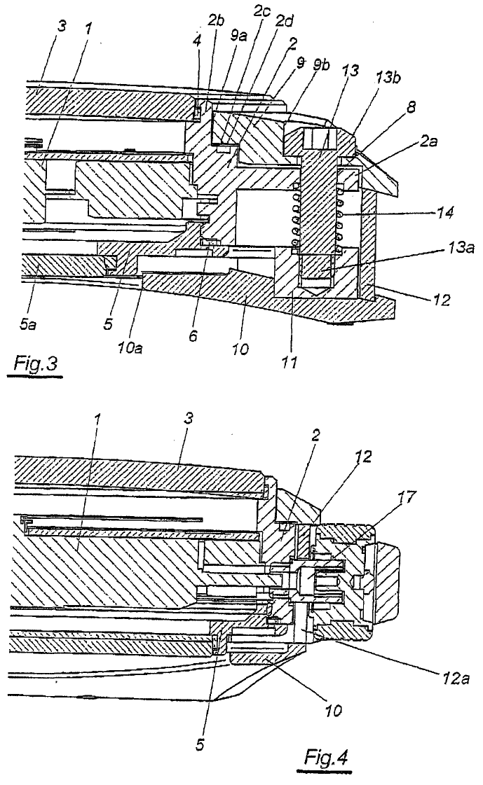

FIG. 3 is a cross section on B-B as marked in FIG. 1; and

FIG. 4 is a cross section on C-C as marked in FIG. 1.

The wristwatch case according to the invention comprises a closed cell for accommodating the movement of the watch 1 and which comprises in this example a middle 2, the upper opening of which is closed by a pressed-in crystal 3 with an interposed seal 4, and the lower opening of which is closed by a screwed back 5 with a seal 6. In the example shown, the back 5 is provided with a transparent center part 5a to allow the movement to be seen. As with all watch cases, this cell is pierced, preferably leaktightly, by at least one control stem 17 (FIGS. 1 and 4). This closed cell thus forms a sealed protective case for the movement 1.

This closed cell is mounted via an elastic suspension which will be described below in a jacket comprising a top component 9 interrupted by a central opening 9a through which passes part 2b of the middle 2 in which the crystal 3 is fixed. A bearing surface 2c of the middle is adjacent to a bearing surface of the top component of the outer jacket. A damper can be housed in an annular housing 2d. The outer jacket also has a back 10 to which four threaded studs 11 are fixed with a spacer 12 interposed between the top component 9 and the back 10. This spacer 12 forms the side wall of the outer jacket and has an aperture 12a (FIG. 4) for the winding stem 17 to pass through. Four posts 13 whose ends terminate in fixing screws 13a are screwed into the corresponding four threaded studs 11. The heads 13b of these screws bear on the bottom of four housings 9b of the top component 9 of the outer jacket.

The outer face of the back 10 of the outer jacket is advantageously curved to follow the shape of the wrist. This back 10 has an opening 10a to allow the transparent part 5a of the back 5 of the inner cell to be seen. This opening 10a also allows the back 5 of the inner cell to be housed partially in the thickness of the back 10 of the outer jacket and to reduce the total height of the watch case.

The middle comprises, on either side of a diametrical line passing through the handsetting stem 7, two suspension components 2a (FIGS. 2 and 4) each containing two through openings, one 8 of which is visible in FIG. 4. A guide post 13 provided with a fixing screw 13 passes through each of the openings 8, so that the middle 2 is able to slide in the outer jacket on the four guide posts 13. A coil spring 14 is placed around each guide post 13, and is arranged between each threaded stud 11 and the suspension components 2a of the middle 2, thus pressing the bearing surface 2c of the middle against the bearing surface of the top component 9 of the outer jacket adjacent to the central opening 9a of this top component.

To fix each of the two halves of the wrist band 15 two screws 16 are screwed from the underside through the respective openings passing through the back 10 of the outer jacket. These screws 16 are screwed into threads 12a formed in the spacer 1 which forms the side wall of the outer jacket, and one of which is visible in FIG. 2, after having passed through an attachment insert 15a for the band 15.

As will be realized on reading the above description, the three components—the top component 9, the back 10 and the spacer 12 that make up the outer jacket in which the inner cell 2, 3, 5 is suspended elastically—are simpler to produce than the components of a standard watch case. As a result, the appearance given to the wristwatch by this jacket can be modified more easily without affecting the inner cell, which has the function of containing and protecting the movement by forming a sealed inner space. Moreover, the elastic suspension of the cell provides the watch movement with added protection against knocks.

1. A case for a wristwatch, comprising a closed cell designed to accommodate a watch movement and having a middle through which there passes at least one control stem and to which there are fixed on the one hand a back and on the other hand a crystal, this closed cell being housed in an outer jacket having a top component containing an opening for the crystal to pass through, a back and a side wall that is provided both with means of connection to the wrist band and with at least one passage for said control stem, elastic means being arranged between the back of the jacket and said cell to apply, to a bearing surface which is part of the middle and is situated at the periphery of said crystal, a pressure such as to keep this bearing surface of the middle permanently applied to the edge of said opening for the passage of the crystal, said case being characterized in that said top component and the back of said jacket are assembled together by screws and are kept apart from each other by said side wall, each screw passing though a suspension component connected to the middle of said closed cell and being surrounded by a coil suspension spring arranged between the back of said jacket and said suspension component.

2. A case for a watch as claimed in claim 1, in which the back of said outer jacket has an opening to allow the passage of a portion of the back of said closed cell.
